(19) United States
(12) Patent Application Publication
(10) Pub. No.: US 2011/0146825 A1
(43) Pub. Date: Jun. 23, 2011

(54) CONDUIT CLOSURE

(75) Inventors: Steffen MADSEN, Orsted (DK); Anders DALSGAARD, Viborg (DK); Bent Holm PETERSEN, Hammel (DK); Jens Christian JENSEN, Bjerringbro (DK)

(73) Assignee: GRUNDFOS MANAGEMENT A/S, Bjerringbro (DK)

(21) Appl. No.: 12/971,529

(22) Filed: Dec. 17, 2010

(30) Foreign Application Priority Data
Dec. 18, 2009 (EP) 09015669.6

(51) Int. Cl. F16L 55/10

(52) U.S. Cl. 138/89

(57) ABSTRACT

A conduit closure serving for the closure of a fluid conduit includes a closure element (4) which may be fastened on a conduit end. A securing element (30) is provided, which closes an opening (28) leading into the conduit inside. The opening (28) is on the closure element (4) or on the conduit (2). The securing element (30) is designed and arranged with respect to the closure element (4), in a manner such that securing element releases the opening (28) before the closure element (4) may be removed from the conduit (2).

### BACKGROUND OF THE INVENTION

The present invention relates generally to a conduit closure with the features specified in the preamble of the independent claim(s).

It is known to close pipe and hose conduits with a closure element which is introduced into the tube conduit end or hose conduit end and which is fasted there. Such closures of conduits are installed in a comparatively simple manner and are accordingly inexpensive. However, such closures mask the danger that when removing the closure element from a conduit which is still subjected to a fluid pressure, this closure element shoots away at high speed. Thus, for example, a closure element introduced into a conduit is pressed out of the pressure conduit at high speed by the fluid pressure prevailing in the conduit, on releasing its fastening, and, as the case may be, may injure the person who has released the fastening of the closure element.

### BRIEF SUMMARY OF THE INVENTION

Against this background, it is an object of the present invention to create a conduit closure which on the one hand is constructed in a simple manner and on the other hand may be safely removed from a conduit.

The above object is achieved by a conduit closure with the features specified in the independent claim(s). Advantageous further formations of this conduit closure are to be deduced from the dependent claims, the subsequent description as well as the drawing. Hereby, according to the present invention, the features specified in the dependent claims, in each case on their own but also in combination, may further form the inventive solution according to the independent claim(s).

The conduit closure according to the present invention serves for closing a fluid conduit, wherein a fluid conduit in the context of the invention is also to be understood as a container for storing a fluid, with which a container opening may be closed with the conduit closure according to the invention. For this, the conduit closure comprises a closure element which may be fastened on a conduit end. With regard to the closure element, it may be the case of an element which may be introduced into the conduit end, or of such an element which may be arranged on the outside on the conduit end. According to the present invention, a securing element is provided, which closes an opening in the closure element or in the conduit, said opening leading into the inside of the conduit. The securing element is designed in a manner, and arranged with respect to the closure element, in a manner such that it releases the opening before the closure element may be removed from the conduit.

This design of the conduit closure according to the present invention forces a person releasing the conduit closure from the conduit, to ascertain whether a fluid is still located in the conduit, before the removal of the closure element from the conduit end, since this fluid, if present, would flow out either via the opening formed either on the closure element or on the conduit, before the removal of the closure element. For this, the securing element closing the opening in a fluid-tight manner, may be moved into a position releasing the opening, without the closure element being able to be removed from the conduit end. Thus, for example, a design in conceivable, with which the securing element blocks the closure element in a position closing the conduit end, in a direct or indirect manner via a coupling to a further component, and this blocking of the closure element is only released by a movement of the securing element relative to the closure element and/or the conduit, said movement releasing the opening, e.g. by way of the removal of the securing element.

According to the present invention, in this context, such a design is also possible, with which the securing element is fixedly connected to the closure element or forms a part of the closure element. Thus, for example, a cap-like closure element which may be fastened for example on the outer periphery of the conduit end, may be provided, which, when it is fastened on the conduit end, with an end section which is distanced to the conduit end and forms a securing element, closes an opening which is correspondingly distanced to the conduit end, on the conduit. With this design, a movement for removing the closure element from the conduit end leads firstly to the opening formed on the conduit being released, wherein by way of a selection of suitable fastening means, for example by way of a fastening by way of thread, thus as a screw cap, it is to be ensured that the closure element although being movable relative to the conduit, hereby however may not be released from the conduit end until after the release of the opening.

The conduit closure according to the present invention has been found to be particularly suitable for closing pressure conduits or pressure containers, thus conduits or containers which are filled with a fluid under pressure. Here, a person wishing to remove the closure element from the conduit end, by way of the fluid flowing out via the opening, recognizes that a fluid under pressure is still present in the conduit, before the closure element may release from the conduit end on its own accord due to the pressure prevailing in the conduit. Thus, before the final removal of the closure element, it is thus possible to reduce the pressure level in the conduit to an adequate extent, for example by way of the outflow of the fluid via the opening or by way of making suitable provisions on removal. Inasmuch as this is concerned, the operation of the conduit closure according to the present invention is significantly safer than with closures of this type which have been known until now.

Preferably, the securing element is releasably fastened on the closure element and/or on the conduit. In this context, the securing element and its fastening may be designed such that the opening closed by the securing element is moved into a position releasing the opening, alone by way of a partial release of the fastening by way of pressure application of a fluid located in the conduit. Hereby, the fastening of the securing element on the closure element or pipe may preferably be effected in an end region surrounding the opening and preferably by way of screw connections.

For fastening the closure element in or on the conduit, one may provide a fastening device which is advantageously secured from a release of the fastening with a removably arranged fastening lock. This means that for the release of the fastening device with which the closure element is fastened on the conduit end, said release being necessary for the removal of the closure element from the conduit end, it is necessary with this design to firstly remove a fastening lock which otherwise prevents the release of the fastening device. The fastening lock may be usefully connected to the securing element, in order to ensure that the securing element closing the opening formed on the closure element or on the pipe, before the removal of the closure element, is moved into a position releasing the opening and thus into a position indicating a presence of fluid in the conduit. Accordingly, a design is preferred, with which the fastening lock, due to its connection with the securing element, may only be removed from the fastening device, when the securing element is moved into a position releasing the opening or is released from the closure element and/or the pipe

Alternatively, a design is conceivable, with which the securing element is a constituent of the fastening device for fastening the closure element in or on the conduit. Hereby, the securing element for the release of the opening formed on the closure element or on the conduit, may be moved in a manner, for example rotatably arranged on the fastening device, such that by way of the movement of the securing element, a fastening lock coupled to the securing element is manipulated such that a removal of the closure element is possible.

The securing element and the fastening lock may be two separate components which are rigidly connected to one another. Preferably however, one envisages the securing element and the fastening lock forming a common component. Accordingly, a component is provided, which on the one hand as a securing element closes the opening formed in the closure element or in the pipe, in a fluid-tight manner, and on the other hand before the release of the opening secures a fastening device for fastening the closure element at the conduit end, against a release of the fastening.

In a preferred design of the conduit closure according to the present invention, the closure element may at least partly be inserted into the conduit end. In this case, the closure element comprises at least one part section with usefully an outer cross section which is complementary to the conduit cross section at the conduit end. Advantageously, a clamp may be provided for fastening the closure element in the conduit end. Basically, a clamp in the context of the present invention is to be understood as any strip which is to be applied around the outer periphery of the conduit, said strip being able to be pulled tight there with all clamping means which are suitable for this, for example by way of a tensioner. Preferably however, one applies a clamp which, in the manner of commercially available hose clip, may be clamped by way of at least one clamping screw.

Advantageously, a section of the component forming the securing element may be fastened on the clamp in a manner such that it blocks an access to the positive fit element which is formed on the head of the clamping screw. This section of the component which is usefully distanced to the section closing the opening on the closure element, inasmuch as this is concerned, forms a fastening lock for the clamp, since the clamping screw may not be released with a suitably designed tool due to the arrangement of the section forming the fastening lock. This is only possible when the securing element, after the release of its fastening on the closure element, is removed from the clamp, so that the positive-fit element formed on the head of the clamping screw is accessible.

In a further formation, the clamp may be fixed on the conduit with a positive fit. For this, at least one projection may be formed on the clamp and this projection engages into a recess formed on the outer peripheral side of the conduit. Vice versa, typically an outwardly projecting projection which engages into a recess or opening formed on the clamp, may also be arranged on the outer peripheral side of the conduit. Preferably, a groove extending over the whole periphery of the conduit is formed on the conduit, wherein an outer edge region of the clamp is designed angled inwards for engaging into the groove. Particularly advantageously, the positive-fit fastening of the clamp on the conduit also permits the positive-fit fastening of the closure element on the conduit end, so that it is also possible to fasten the closure element on rigid conduit ends by way of the clamp.

Hereby, the clamp may advantageously at least partly grip around the conduit end and the closure element which is fastened thereto. Accordingly, the clamp at a peripheral edge region may comprise at least one projection which is directed into the inside of the clamp and which extends directly on the outer side of the conduit end, radially in the direction of a middle axis of the conduit and thus secures the closure element located the conduit, against a movement out of the conduit end. Preferably, one envisages a peripheral end section of the clamp being angled pointing into the inside of the clamp, and engaging around the conduit end and the closure element transversely to the longitudinal extension of the conduit and closure element.

In particular, when a component simultaneously forms the securing element for closing the opening formed on the closure element, and the fastening lock for the clamp, it has been found to be useful if the clamp may be fixed in a defined position on the conduit. In this case, the fixation of the clamp is typically effected in a manner such that the securing element on the one hand may close the opening on the closure element and on the other hand may secure the fastening of the clamp on the conduit, by way of the fastening lock being arranged at the corresponding location on the clamp. For fixing the clamp on the conduit, an opening may advantageously be formed on the clamping strip of the clamp, into which opening a projection formed on the peripheral surface of the conduit engages.

Preferably, an angle element is provided, with which a first limb forms a cover for the opening formed on the closure element, and a second limb, which is aligned normally to the first limb, forms a fastening lock. Accordingly, the securing element may be created in a simple and inexpensive manner from a sheet-metal piece, with which at least two sheet-metal sections are angled to one another such that in the installed condition of the angle element, a first sheet-metal section covers the opening formed on the closure element, and a second sheet metal section secures the fastening of the clamp, for example by way of blocking the access to the head of a clamping screw.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a simplified, schematic perspective view of an end section of a conduit with a conduit closure arranged at the conduit end;

FIG. 2 is an enlarged perspective view of a part detail of the conduit closure according to FIG. 1;

FIG. 3 is the part detail of the conduit closure shown in FIG. 2 with the fastening of a securing element in an exploded representation;

FIG. 4 is an end-side view of the conduit end with a conduit closure according to FIG. 1; and

FIG. 5 is an enlarged view of the conduit end with a conduit closure shown in FIG. 4, taken along line V-V of FIG. 4.

### DETAILED DESCRIPTION OF THE INVENTION

Certain terminology is used in the following description for convenience only and is not limiting. The words “inwardly” and “outwardly” refer to directions toward and away from, respectively, the geometric center of the device and designated parts thereof. The terminology includes the words specifically mentioned, derivatives thereof and words of similar import. Additionally, the word “a” as used in the specification means “at least one.”

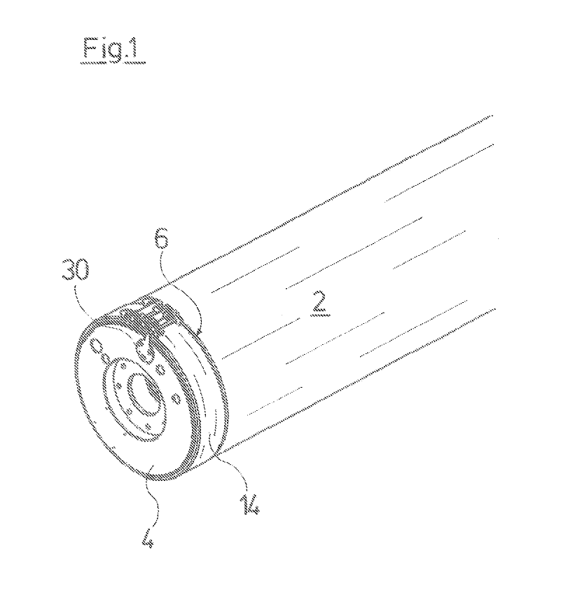

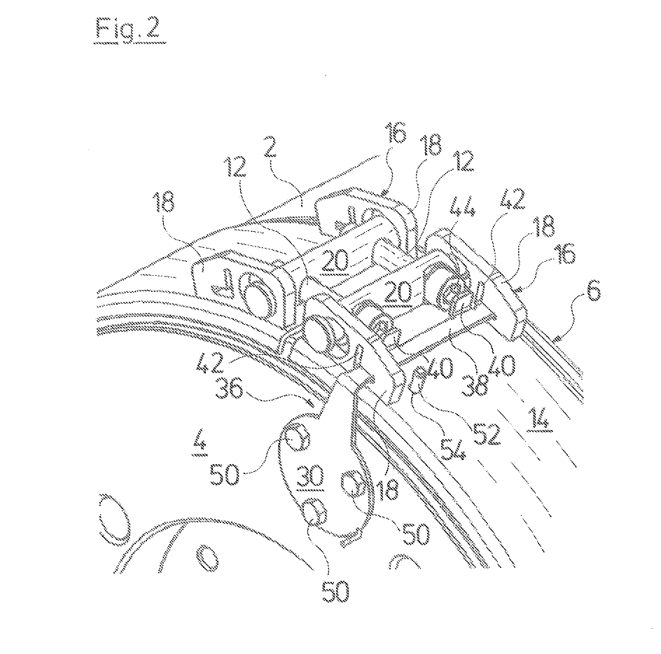

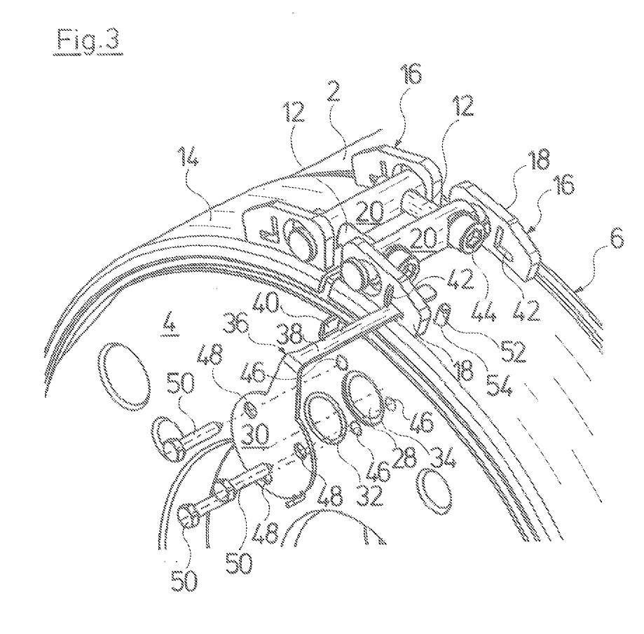

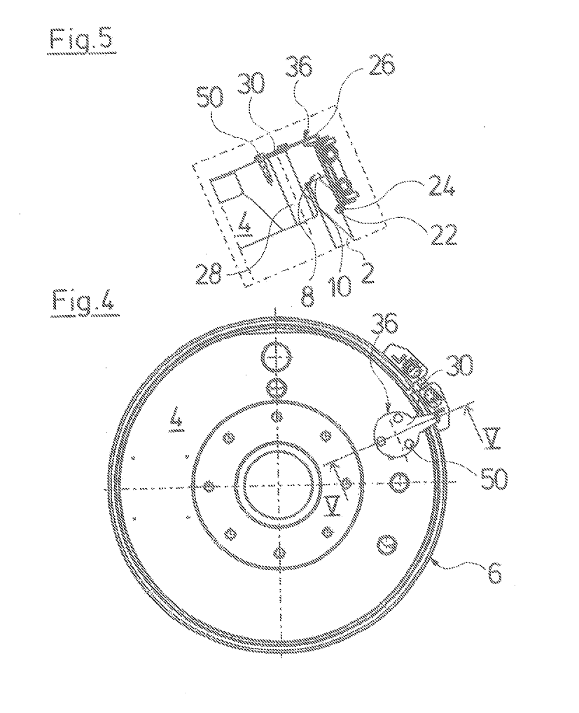

Referring to the drawings in detail, wherein like numerals indicate like elements throughout, there is shown in FIGS. 1-5 a conduit 2 for leading a fluid, and which is formed by a pipe 2, is closed by way of a conduit closure. The conduit close preferably comprises a closure element 4 which is fastened on a conduit end of the conduit 2 by way of a clamp 6. As is evident from FIG. 5, the closure element 4 preferably tapers in the longitudinal direction in a shouldered manner from a first section, in which the outer cross section of the closure element 4 corresponds to the outer cross section of the conduit 2, to a second section, in which the outer cross section of the closure element 4 corresponds to the opening cross section of the conduit 2.

The second section of the closure element 4 is envisaged for engagement into the conduit end of the conduit 2, while the first section of the closure element 4 serves for bearing on the end-side of the conduit 2 which forms the conduit end. An annular groove 8 is preferably formed on a flat side of the first section of the closure element 4, said flat side forming a part of the shoulder from the first to the second closure element section and being directed radially to the outside. The annular groove 8 extends around the periphery of an annularly designed flat side. The annular groove 8 serves for receiving a sealing ring 10, with which the closure element 4 is sealed in a fluid-tight manner with respect to the conduit 2.

The fastening of the clamp 6 on the peripheral surface of the conduit 2 and on the section of the closure element 4, which projects out of the end of the conduit 2, is effected by way of two clamping screws 12. For this, a bracket 16 which is formed by two components 18 arranged on the outer edges of a clamping strip 14 and connected to a pin 20, is arranged on each of the two ends of the clamping strip 14 of the clamp 6. Hereby, the pins 20 are mounted in a loose manner on the two components 18 which are arranged lying opposite one another at one end of the clamping strip 14, in elongate holes formed there. The two pins 20 of the brackets 16 may be screwed to one another by way of clamping screws 12 for tightening the clamping strip 14.

The clamp 6 is fastened on the conduit 2 with a positive fit. For this purpose, a groove 22 is formed in a region of the conduit 2 which connects to the conduit end, and this groove extends over the whole outer periphery of the conduit 2 (see FIG. 5). An edge section 24 of the clamping strip 14 of the clamp 6 engages into this groove 22 and is angled in the direction of the inside of the clamp 6. In order to be able to arranged the clamping closure of the clamp 6 in a defined position with respect to the outer periphery of the conduit 2, a radially outwardly projecting projection 23 is formed on the conduit 2, and an opening 25 is formed on the clamping strip 14 of the clamp 6, wherein the projection 23 engages through the opening 25.

An end section 26 of the clamping strip 14 which lies opposite the edge section 24, is likewise angled essentially in the direction of the inside of the clamp. This edge section 26 engages around the closure element 4 at an end region which is away from the conduit 2, and in this manner fixes the closure element 4 on the conduit 2 with a positive fit.

An opening 28 is formed on the closure element 4 at the end-side, and creates an access from the inside of the conduit 2 to outside the closure element 4. The opening 28 is closed by a securing element 30, wherein a sealing ring 32 is provided between the closure element 4 and the securing element 30 for the fluid-tight sealing. The sealing ring 32 is arranged on a shoulder 34 which is formed on the outer opening edge of the opening 30.

The securing element 30 is part of a component 36 which also forms a fastening lock for the clamp 6. For this, the component 36 is designed as an angle element 36 which comprises a first limb, with which a circular extension forms the securing element 30, and an elongate second limb 38 which is directed essentially normally to the first limb, forms the fastening lock for the clamp 6. Two projections 40 which are distanced to one another are formed on the limb 38 and are aligned normally to the base body of the limb 38.

The limb 38 is fastened on a bracket 16 of the clamping closure of the clamp 6 with a positive fit. For this, the two components 18 forming part of the bracket 16 in each case comprise an L-shaped opening 42, through which the limb 38 is led. In the installed position of the component 36, the projections 40 formed on the limb 38 are arranged in front of the heads of the clamping screws 12, in a manner such that they block the access to the positive-fit elements 44 formed on the heads.

The component 36 is fastened on the closure element 4. For this, three openings 48, which serve for receiving screws 50 screwed into the threaded pocket holes 46, are formed on the section of the component 36 which forms the securing element 30, in a manner corresponding to three threaded packet holes 46 formed on the closure element 4 in the edge region of the opening 28. Although the fastening by way of three screws 50 is preferred, it is to be noted that the component 36 may also be fastened on the closure element 4 with more than three screws 50.

In order to be able to fix the limb 38 of the component 36 on the bracket of the clamping closure of the clamp 6 with a positive fit, it is necessary to position the clamp 6 on the conduit 2 at a location which is suitable for this. In order to ensure such a positioning of the clamp 6, a radially outwardly projecting positioning pin 52 is arranged on the outer periphery of the conduit 2 and is provided for engagement into an opening 54 which is correspondingly formed on clamping strip 14 of the clamp 6.

The manner of functioning of the conduit closure represented in the drawing is as follows.

It is necessary to release the clamp 6 for removing the closure element 4 from the conduit 2, i.e. for opening the conduit closure. This is firstly not possible, since the projections 40 on the limb 38 of the component 36 block an access to the positive-fit elements 44 which a reformed on the heads of the clamping screws 12. Accordingly, the component 36 for releasing the clamping screws 12 must firstly be removed.

For this, the screws 50 which hold the component 36 on the closure element 4, must be released. Already after the release of a first of the screws 50, a fluid which is possibly in the conduit 2 and which is under pressure, may flow out via a gap forming between the securing element 30 and the closure element 4 due to the fluid pressure. By way of this, a reduction of the fluid pressure prevailing in the conduit 23 occurs, or a continuous fluid flow, which indicates to the operating person that the conduit is under pressure. On reaching a sufficiently reduced pressure level in the conduit 2, the component 36 may be removed, wherein the limb 38 may be pulled out of the openings 42 which are formed on the components 18 of the bracket 16. Subsequently, the positive fit elements 44 which are formed on the heads of the clamping screws 12 are freely accessible, so that the clamping screws 12 and, entailed by this, the clamp 6, may be released from the conduit 2 and the closure element 4. It is now possible to remove the closure element 4 from the conduit end of the conduit 2 without any danger.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A conduit closure with a closure element (4) which may be fastened on a conduit end (4), the conduit closure comprising a securing element (30) which closes an opening (28) on the closure element (4) or on the conduit (2) and leading into an inside of the conduit, said securing element being designed and arranged with respect to the closure element (4) in a manner such that the securing element releases the opening (28) before the closure element (4) may be removed from the conduit (2).

2. The conduit closure according to claim 1, wherein the securing element (30) is releasably fastened on the closure element (4) or on the conduit (2).

3. The closure element according to claim 1, wherein a fastening device for fastening the closure element (4) in or on the conduit (2) is secured from a release of the fastening by way of a removable arranged fastening lock.

4. The conduit closure according to claim 3, wherein the fastening lock is connected to the securing element (30).

5. The conduit closure according to claim 3, wherein the securing element (30) and the fastening lock form a common component (36).

6. The conduit closure according to claim 1, wherein the closure element (4) at least partly introduced into the conduit end, and a clamp (6) is provided for fastening the closure element (4), said clamp (6) being clamped at least onto the conduit (2) by way of at least one clamping screw (12).

7. The conduit closure according to claim 6, wherein a section of a component (36) forming the securing element (30), may be fastened on the clamp (6) in a manner such that it blocks an access to a positive-fit element (44) formed on the head of the clamping screw (12).

8. The conduit closure according to claim 6, wherein the clamp (6) is fastened on the conduit (2) with a positive fit.

9. The conduit closure according to claim 6, wherein the clamp (6) at least partly grips around the conduit end and the closure element (4) which is fastened thereon.

10. The conduit closure according to claim 6, wherein clamp (6) is fixed on the conduit (2) in a defined position.

11. The conduit closure according to claim 1, wherein an angle element (36) is provided, with which a first limb forms a securing element (30) as a covering for the opening (28) formed on the closure element (4), and a second limb (38) aligned normally to the first limb forms a fastening lock.
